(19) United States
(12) Patent Application Publication
(10) Pub. No.: US 2023/0028859 A1
(43) Pub. Date: Jan. 26, 2023

(54) SYSTEM AND METHOD FOR ACCEPTING DIFFERENT CURRENCIES IN PAY-TO-PRINT PRINTING

(71) Applicant: Toshiba TEC Kabushiki Kaisha, Shinagawa-ku (JP)

(72) Inventor: John N. deWaide, Lake Forest, CA (US)

(21) Appl. No.: 17/380,597

(22) Filed: Jul. 20, 2021

(51) Int. Cl. G06Q 20/32; H04N 1/00; G06K 7/14; G06K 7/10; G06Q 20/06

(52) U.S. Cl. CPC G06Q 20/3274; H04N 1/00411; H04N 1/00506; H04N 1/00244; G06K 7/1413; G06K 7/10722; G06Q 20/065

(57) ABSTRACT

A system and method for pay-to-print printing allows a pay-to-print user to pay from any source currency to target currency through the use of a cryptocurrency service. A user selects a job to be performed on an MFP, and a job cost is generated and displayed. The MFP generates and displays a barcode on its touchscreen. The user scans the barcode and their smartphone is directed to a payment service portal, such as Google Pay or Apple Pay. The user directs payment to a crypto currency sever, along with payment target and target currency for the job. The cryptocurrency server converts payment to its cryptocurrency, and then to the target currency, and relays the target currency to target. The MFP completes the job once payment has been made.

### TECHNICAL FIELD

This application relates generally to pay-to-print printing. The application relates more particularly to use of online cryptocurrency service systems to accomplish rapid and inexpensive currency conversion from a user's payment currency to a printing service currency.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Document processing may incur a charge, such as cost per page for black-and-white, cost per page for color, document finishing cost, and the like. A cost may be assessed once a user sends a print job to an MFP and selects their printing options. Document processing costs may also be set for non-printing document processing operations, such as e-mailing, faxing, scanning or copying. As used herein, all document processing functions for which a charge may be made are collectively referred to as pay-to-print.

Pay-to-print operations may involve swiping a credit or debit card on an MFP, manually entering payment information, or debiting a pre-paid account.

### BRIEF DESCRIPTION OF THE DRAWINGS

Various embodiments will become better understood with regard to the following description, appended claims and accompanying drawings wherein:

FIG. 1 is an example embodiment of a system for accepting different currencies in pay-to-print printing;

FIG. 2 is an example embodiment of a networked digital device, such as a multifunction peripheral;

FIG. 3 is an example embodiment of a digital device system, such as a server, smartphone or tablet computer;

FIG. 4 illustrates a flowchart of an example embodiment of a system for accepting different currencies in pay-to-print printing;

FIG. 5 illustrates a flow diagram of an example embodiment of a system for accepting different currencies in pay-to-print printing; and

FIG. 6 illustrates a flowchart of another example embodiment of a system for accepting different currencies in pay-to-print printing.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

A pay-to-print application on an MFP deployed in multiple countries poses a problem of currency conversion, including conversion transaction fees and slow transaction clearance time. Currency conversion may require a conversion fee, adding to costs or decreasing profitability. In addition to MFPs deployed in different countries, MFPs may also be placed where people from different countries share an MFP, such as when an MFP is publicly available near a country border or in an international airport or train station.

Early payments involved a physical exchange of currency for goods or services. More recently, most transactions are electronic and completed in a single currency. Conversions can be automatic, such as when a credit card using one currency is used at a location using another. Conversions, such as by a credit agency, often entail a fee which must be borne by a card holder, a business or both.

Still more recent is the advent of cryptocurrency. A cryptocurrency, cryptocurrency, or crypto is a digital asset designed to work as a medium of exchange wherein individual “coin” ownership records are stored in a ledger existing in a form of a computerized database, using strong cryptography to secure transaction records, to control creation of additional coins, and to verify the transfer of coin ownership. Cryptocurrency does not exist in physical form, like paper money, and is typically not issued by a central authority. Cryptocurrencies typically use decentralized control as opposed to a central bank digital currency. When a cryptocurrency is “minted” or created prior to issuance or issued by a single issuer, it is generally considered centralized. When implemented with decentralized control, each cryptocurrency works through distributed ledger technology, typically a blockchain, which serves as a public financial transaction database. Bitcoin, first released as open-source software in 2009, is the first decentralized cryptocurrency. Since the release of bitcoin, many other cryptocurrencies have been created.

Example embodiments herein utilize cryptocurrency that can be leveraged to accept payments in any fiat currency. An MFP pay-to-print app connects with any suitable cryptocurrency system, such as the Steller cryptocurrency network or Algorand. Example embodiments herein access any suitable cryptocurrency network, such as Stellar or Algorand. Example embodiments herein implement the Stellar network. This network offers a cryptocurrency capable of achieving extremely high-throughput of transactions, such as 1,500 per second, with extremely low fees. In the Stellar network, Stellar, Stellar Lumens or XLM is used, hereinafter referred to as XLM. XLM is an open source, decentralized protocol for digital currency to fiat money low-cost transfers which allows cross-border transactions between any pair of currencies. Example transaction fees, may be set to a default of 0.00001 lumens, XLM, which is currently equivalent to 0.000004 United States cents. The MFP pay-to-print app accepts payment in any currency, connects to the Stellar Network, exchanges that currency for XLM, then immediately exchanges that XLM for United States dollars, or any other target currency. This results in fast currency conversion as well as low transaction fees. A single application is suitably implemented one time to handle “any-to-any” transactions via the use of cryptocurrency. Application of cryptocurrency provides fast and low-fee cross-currency transactions with pay-to-print.

Example embodiments herein begin with an MFP application that is connected to a backend web application. The backend web application is responsible for generating a code, such as a barcode which may comprise a QR code, encoding a payment link that is displayed on the MFP's screen when the user uses pay-to-print on the MFP. Once the user initiates payment, the web application accepts that payment and connects with a cryptocurrency network to do a very fast, low-fee conversion from the user's local currency to whatever target currency an operator of the pay-to-print set up desires. The web application then deposits the funds into the operator's financial account once conversion is successful.

Leveraging a web application to connect to a cryptocurrency network can aid in accepting universal payments in any currency with lower fees, lower slippage, and lower clearance time than that typically associated with cross-currency transactions.

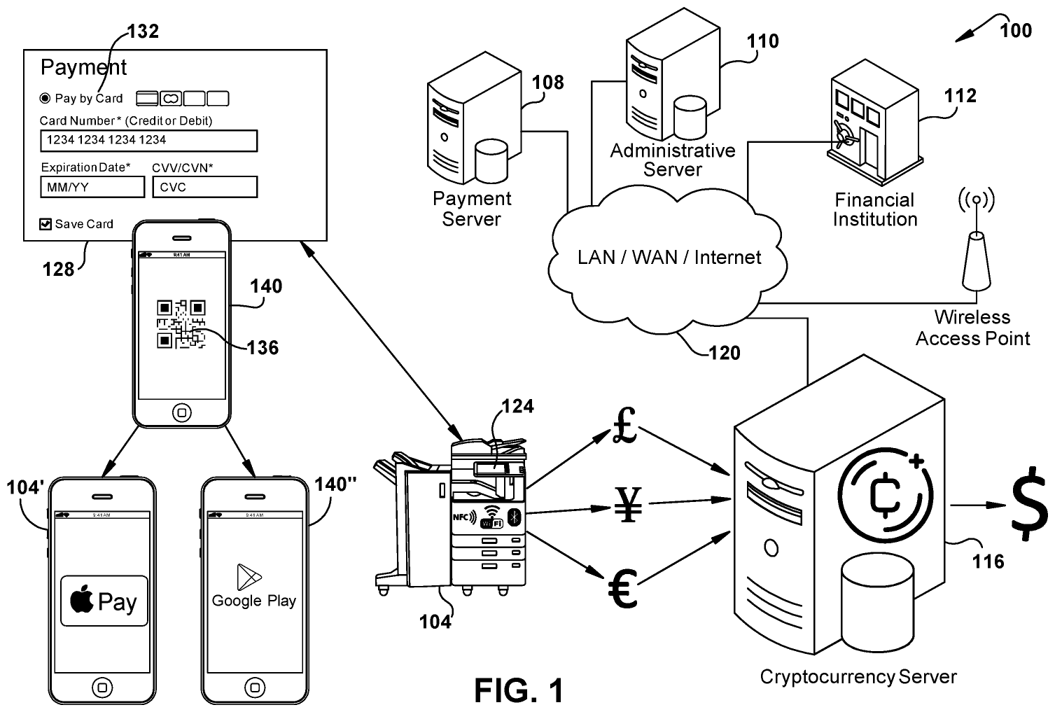

FIG. 1 illustrates an example embodiment of a system 100 for accepting different currencies in pay-to-print printing. One or more MFPs, such as MFP 104, payment server 108, administrative server 110, financial institution 112, cryptocurrency server 116, are in data communication via network cloud 120. Network cloud 120 is suitably comprised of a local area network (LAN), a wide area network (WAN) which may comprise the Internet, or any suitable combination thereof. Network cloud 120 includes any suitable data pathway, including wired or wireless data communication.

MFP 104 includes a user interface 124, suitably comprised of a touchscreen. A user wishing to engage pay-to-print services on MFP 104 sends or transfers a print job to MFP 104, and selects one or more pay-to-print operations. Once selected, a total cost is calculated and displayed, as well as a payment screen, such as payment screen 128. Payment screen 128 includes one or more payment types. In the example illustration, a standard credit card entry field is illustrated at 132. Such entry allows for securing funds from financial institution 112, suitably comprised of a credit card agency, bank, savings and loan, or the like. Also illustrated is a barcode 136 generated by MFP 104, which is a QR code in the illustrated example embodiment. Barcode 136 encodes a link to financial institution 112. A portable user data device, such as a smartphone or tablet computer includes a digital camera and a barcode reader. In the illustrated example, smartphone 140 is directed to barcode 136, which, once decoded connects to payment server 108. Such a service may include any suitable payment service, such as Google Pay, Apple Pay, Samsung Pay, or the like. Thus, funding may be supplied from either payment server 108 or financial institution 112 in a source currency associated with a user. As used herein, a financial service is comprised of payment server 108, financial institution 112, or both.

Payment server 108 or financial institution 112 relays funding information to cryptocurrency server 116, along with a target currency, suitably specified by administrative server 110 which oversees MFP pay-to-print operations. Cryptocurrency server 116 converts received funding into its cryptocurrency, and then immediately converts the cryptocurrency to the target currency and sends it to administrative server 110. Once payment is confirmed, administrative server 110 notifies MFP 104, and the user's pay-to-print job is processed.

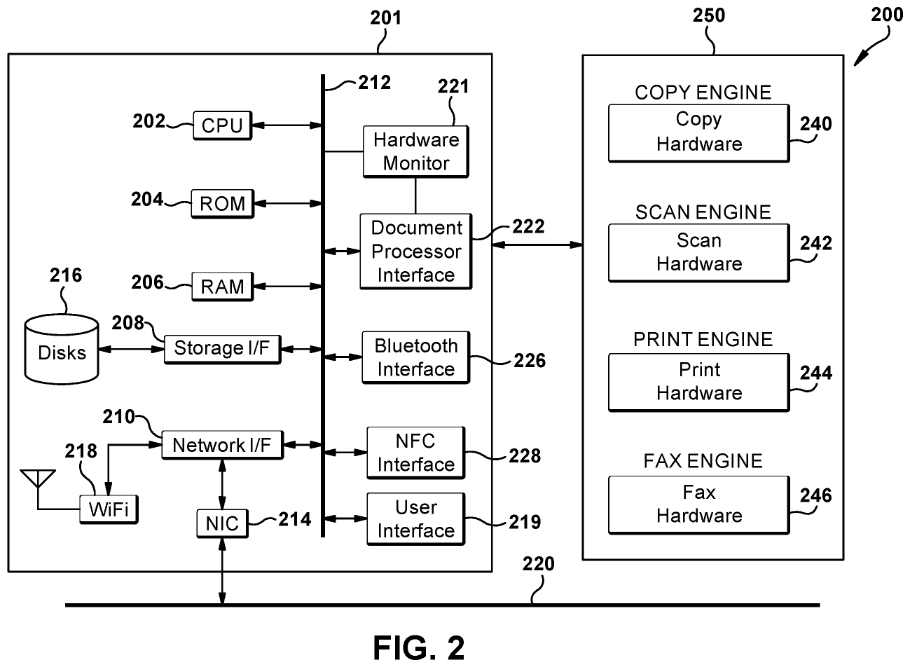

Turning now to FIG. 2, illustrated is an example embodiment of a networked digital device comprised of document rendering system 200 suitably comprised within an MFP, such as with MFP 104 of FIG. 1. It will be appreciated that an MFP includes an intelligent controller 201 which is itself a computer system. Thus, an MFP can itself function as a server with the capabilities described herein. Included in intelligent controller 201 are one or more processors, such as that illustrated by processor (CPU) 202. Each processor is suitably associated with non-volatile memory, such as read-only memory (ROM) 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired interface or physical network connection 220, or to a wireless data connection via wireless network interface 218. Example wireless data connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with user interface 219 for interfacing with displays, keyboards, touchscreens, mice, trackballs and the like.

Processor 202 can also be in data communication with any suitable input/output (I/O) user interface 219 which provides data communication with user peripherals, such as displays, keyboards, mice, track balls, touch screens, or the like.

Also in data communication with data bus 212 is a document processor interface 222 suitable for data communication with the document rendering system 200, including MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

Processor 202 can also be in data communication with any suitable user input/output (I/O) interface 219 which provides data communication for interfacing with user peripherals, such as displays, keyboards, mice, track balls, touch screens, or the like. Processor 202 can also be in communication with hardware monitor 221, such as a page counter,

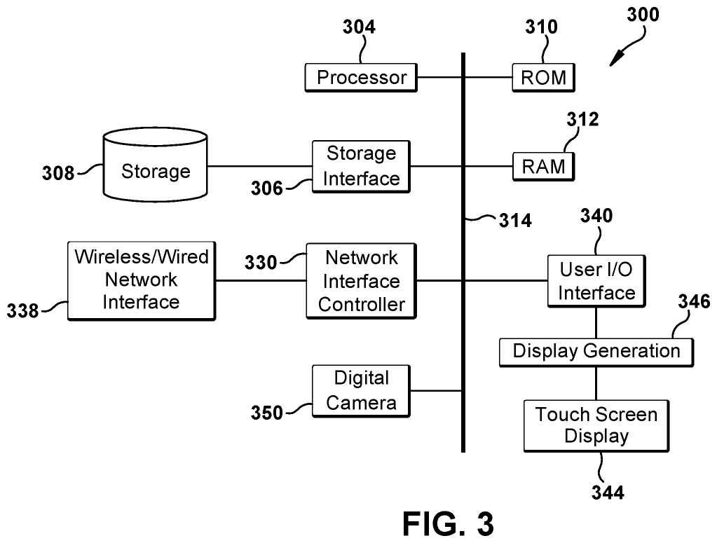

Turning now to FIG. 3, illustrated is an example embodiment of a digital data processing device 300 such as servers 108, 110, and 116, as well as smartphone 140 of FIG. 1. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. A network interface controller 330 suitably provides a gateway for data communication with other devices, such as via wireless network interface 338. A user input/output interface 340 suitably provides display generation 346 providing a user interface via touchscreen display 344, suitably displaying images from display generator 346. Also in data communication with processor 304 is digital camera 350. It will be understood that the computational platform to realize the system as detailed further below is suitably implemented on any or all of devices as described above.

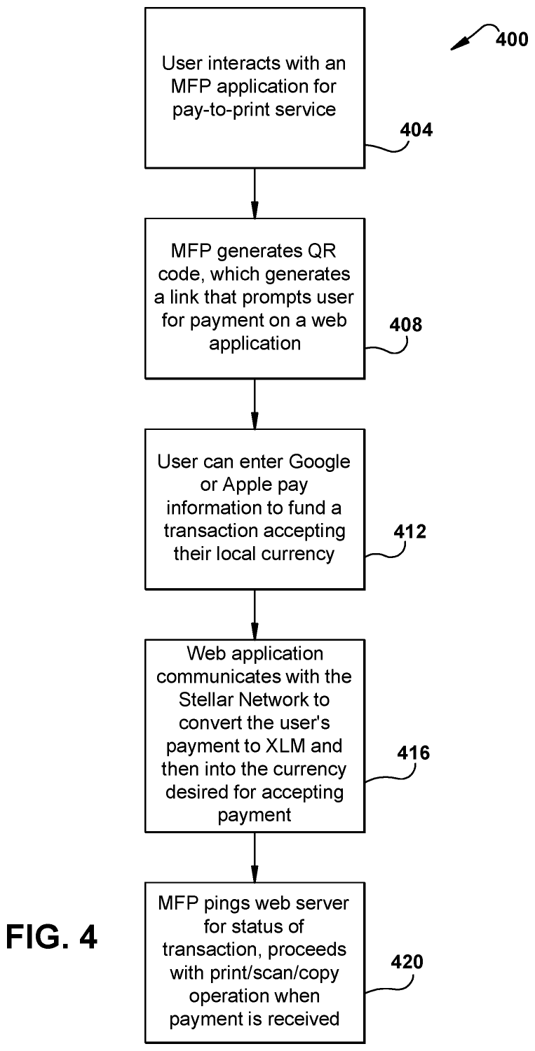

FIG. 4 is a flowchart 400 of an example embodiment of a system for accepting different currencies in pay-to-print printing. In block 404, a user interacts with an MFP for pay-to-print services. Next, in block 408, the MFP generates and displays a QR code containing an encoded link for prompting a user for payment, suitably via a web application. A user enters payment information, such as Google Pay or Apple Pay for payment in their local currency at block 412. Next, at block 416, the web application communicates with the Stellar network, converts the source currency into XLM and then into a desired target currency. Next, at block 420, the MFP pings a web server for transaction status, and proceeds with the requested pay-to-print service when payment is confirmed.

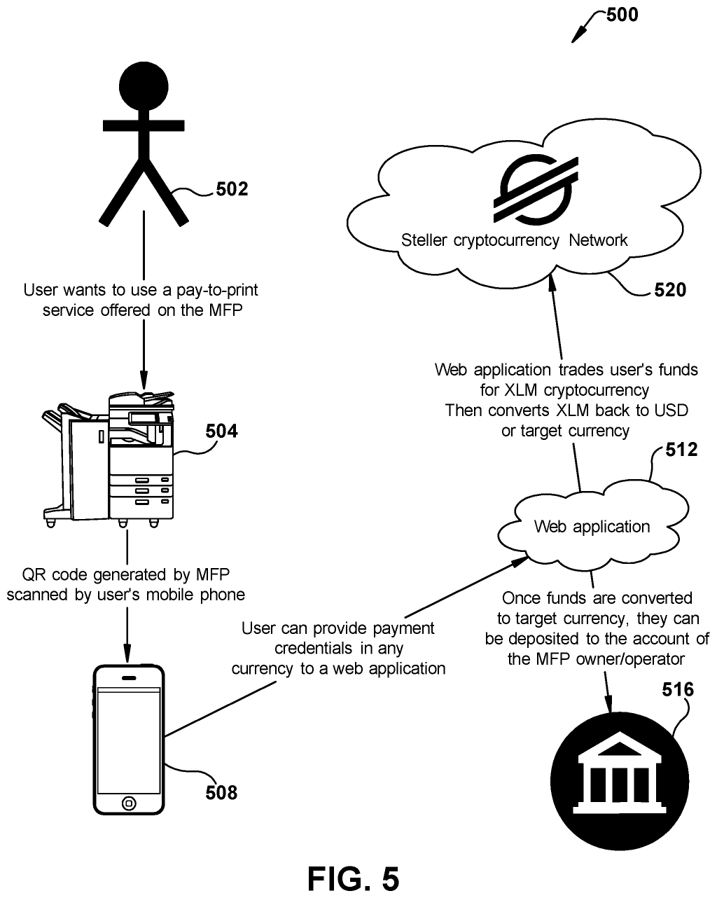

FIG. 5 illustrates flow diagram 500 of example embodiment of a system for accepting different currencies in pay-to-print printing. User 502 seeks a pay-to-print service on MFP 504, which generates a QR code captured by the user's smartphone 508. The decoded QR code launches web application 512 on smartphone 508, and provides a link to a payment server or financial institution 516. Payment information in a source currency and instructions for a target currency are sent to cryptocurrency server 520, which converts the source currency into cryptocurrency, and then into the target currency and relays payment, less a small transactional fee.

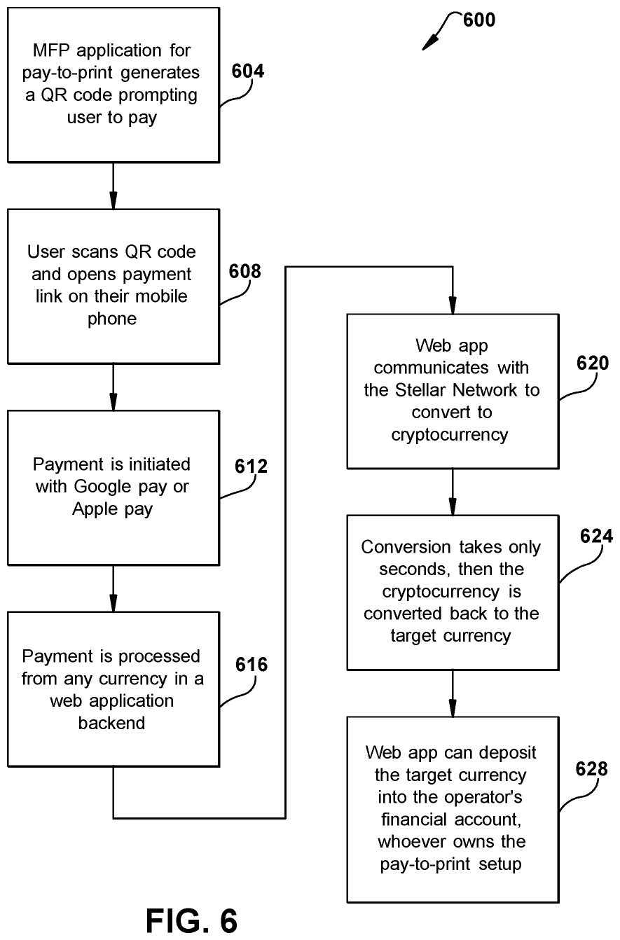

FIG. 6 illustrates flowchart 600 of another example embodiment of a system for accepting different currencies in pay-to-print printing. An MFP application is engaged at block 604 for pay-to-print services, and a QR coded prompting a user for payment for their pay-to-print job. Next, at block 608, the user scans the generated QR code and opens a web payment link app on their smartphone. Payment is initiated with a financial service, such as Google Pay or Apple Pay at block 612. Payment is processed at block 616 in a currency associated with the financial service at block 616. The web payment link app communicates the payment to the Stellar Network at block 620. The Stellar Network server converts received payment into its cryptocurrency, and immediately into a target currency at block 624. Funds in the target currency are then transferred to an MFP administrator or operator's financial account at block 628.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
at least one processor and associated memory;
a user interface including at least one display and at least one user input;
a document processing engine;
at least one data interface;
the user interface configured to receive a payment instruction for a cost associated with a selected document processing operation, the payment instruction including a payment amount in a first currency type from a financial service;
the at least one processor configured to initiate, via the at least one data interface, payment in the payment amount from the financial service to a cryptocurrency server with an instruction to forward payment to a specified recipient in a second currency; and
the at least one processor further configured to initiate the selected document processing operation on the document processing engine.

2. The system of claim 1 wherein the at least one processor is further configured to initiate the selected document processing operation in connection with a payment confirmation received via the at least one data interface.

3. The system of claim 1 wherein the at least one processor is further configured to display a barcode on the user interface, the barcode including encoded instructions to access a payment portal website for entry the payment instruction.

4. The system of claim 3 further comprising digital camera configured to capture an image of the barcode, and wherein the at least one processor is further configured decode a captured barcode image and access and display the payment portal website on the user interface.

5. The system of claim 4 wherein the user interface is comprised of an MFP touchscreen and a portable data device touchscreen.

6. The system of claim 5 wherein the payment portal website is associated with the financial service.

7. The system of claim 6 wherein a multifunction peripheral comprises the document processing engine and wherein the specified recipient is comprised of a payment server associated with the multifunction peripheral.

8. The system of claim 7 wherein the multifunction peripheral comprises the payment server.

9. A method comprising:
receiving, from a user interface including at least one display and at least one user input, a payment instruction for a cost associated with a selected document processing operation, the payment instruction including a payment amount in a first currency type from a financial service;
initiating, via at least one data interface, payment in the payment amount from the financial service to a cryptocurrency server with an instruction to forward payment to a specified recipient in a second currency; and
initiating the selected document processing operation on a document processing engine.

10. The method of claim 9 further comprising initiating the selected document processing operation in connection with a payment confirmation received via the at least one data interface.

11. The method of claim 9 further comprising displaying a barcode on the user interface, the barcode including encoded instructions to access a payment portal website for entry the payment instruction.

12. The method of claim 11 further comprising:
capturing an image of the barcode via a digital camera; and
decoding a captured barcode image; and
accessing and displaying the payment portal website on the user interface in accordance with a the decoded captured barcode image.

13. The method of claim 12 wherein the user interface is comprised of an MFP touchscreen and a portable data device touchscreen.

14. The method of claim 13 wherein the payment portal website is associated with the financial service.

15. The method of claim 14 wherein a multifunction peripheral comprises the document processing engine and wherein the specified recipient is comprised of a payment server associated with the multifunction peripheral.

16. The method of claim 15 wherein the multifunction peripheral comprises the payment serer.

17. A method comprising:
receiving a document processing instruction,
associating a cost with a received document processing instruction;
displaying a payment portal;
receiving a payment instruction via the displayed payment portal for payment of the cost;
sending the payment instruction to a financial service for payment of the cost in a first currency for payment in a second currency;
converting the first currency into cryptocurrency;
converting the cryptocurrency to the second currency;
sending the second currency to a specified recipient; and
completing the document processing instruction.

18. The method of claim 17 further comprising:
generating a barcode;
displaying a generated barcode;
capturing an image of the generated barcode;
decoding a captured image of the barcode;
displaying the payment portal in accordance with a decoded captured image.

19. The method of claim 18 further comprising:
receiving a payment confirmation after sending the second currency to the specified recipient; and
completing the document processing instruction after receipt of payment confirmation.

20. The method of claim 19 further comprising:
receiving the document processing instruction on a user interface of a multifunction peripheral;
generating the barcode via a processor of the multifunction peripheral;
displaying the generated barcode on the user interface of the multifunction peripheral;
capturing the image via a digital camera of a portable data device;
decoding the captured image via a processor of the portable data device;
displaying the payment portal on a user interface of a the portable data deice;
converting the first currency to the cryptocurrency via the financial service;
converting the cryptocurrency to the send currency via the financial service; and
sending the second currency to the specified recipient comprised of a payment server associated with the multifunction peripheral.
